(19) United States
(12) Patent Application Publication
(10) Pub. No.: US 2015/0071734 A1
(43) Pub. Date: Mar. 12, 2015

(54) self-wedging concrete nail

(71) Applicant: Herman Vallejo, Sunland, CA (US)

(72) Inventor: Herman Vallejo, Sunland, CA (US)

(21) Appl. No.: 14/019,539

(22) Filed: Sep. 6, 2013

(51) Int. Cl. F16B 15/00

(52) U.S. Cl. CPC F16B 15/00
USPC 411/491

(57) ABSTRACT

A concrete fastener with ribs attached to the body that, when driven into a pre-drilled hole, the ribs collapse due to the friction between the concrete/CMU and the fastener ribs creating a temporary or permanent attachment between the objects.

### CROSS-REFERENCE TO RELATED APPLICATIONS

This application claims the benefit of provisional patent application Ser. No. 61/743,735, filed 2012 Sep. 11 by the present inventor

### BACKGROUND-PRIOR ART

The following is a tabulation of some prior art that presently appears relevant:

U.S. Patents

| Pat. No. | Kind Code | Issue Date | Patentee |
|---|---|---|---|
| 7,587,873 | B2 | 2009-09-15 | Mesherry/McDuff |
| 5,562,377 | | 1996-10-8 | Giannuzzi |
| 8,434,981 | B2 | 2013-05-7 | Bosterling et al. |

U.S. Patent Application Publications

| Publication Nr. | Kind Code | Publ. Date | Applicant |
|---|---|---|---|
| EP2085624 | A1 | 2009-08-5 | Takanori |

The building industry commonly uses two nails to join, permanently or temporarily, wood or other building materials to hardened concrete or concrete masonry units. The present invention only requires one nail to affix these materials, wood or other materials, to hardened concrete or concrete masonry units.

The present invention uses collapsible ribs, which are attached to a body, to fasten wood or other building materials to cured concrete or concrete masonry units. The present invention eliminates the use of expansion anchors, shot-in anchors, epoxy anchors, screwed-in anchors, or two nails by using a “self-wedging concrete nail.” Expansion anchors, U.S. Pat. No. 7,587,873 when inserted, sometimes fail because they do not engage and are not removable. If there is not sufficient distance from the edge, the concrete can fracture or break.

Shot-in anchors, EP 2085624, are not practical for temporary use as they are not able to be removed without spaulding of the concrete. They require a distance from the edge because closeness to the edge may crack or break the concrete. They are not practical for concrete over 3,000 psi because they tend to spauled the concrete. Deep Penetration is hard to achieve especially in concrete over 3,000 psi.

Epoxy anchors, U.S. Pat. No. 5,562,377, are not practical for temporary or permanent use due to time consumption of the epoxy curing, the projection of the heads, the large holes needed for installation, more than one part for assembly, and cannot be removed without the use of a cutting tool.

“Screwed-in anchors, U.S. Pat. No. 8,434,981 B2, are not always appropriate due to the projecting head and the difficulty of screwing into cured concrete. They are not practical for temporary use due to the difficulty of removal because the head becomes occluded with concrete.

Two nails, which are used for temporary frame work, are not cost effective and require the time consumption of finding two same diameter nails to fit into a proper pre-drilled holes. They also cannot be used in finish work due to the appearance left by the nails.

### BRIEF DESCRIPTION OF DRAWINGS

FIG. 1A shows an isometric front view of a single-headed nail showing item 11, which is the point; item 21, which is the shaft; item 31, which are the vertically protruding multiple ribs; item 41, which is a head; item 1C, which is a plan view of a cross-section through the shaft.

FIG. 1B shows an isometric front view of a double-headed nail showing item 11, which is the point; item 21, which is the shaft; item 31, which are the vertically protruding multiple protruding ribs; item 41, which is a head; item 52, which is a duplex head; item 1C, which is a plan view of a cross-section through the shaft.

FIG. 1C shows a plan view of a cross-section of the shaft showing item 21, which is the shaft; item 31, which is the protruding ribs.

FIG. 2A shows an isometric front view of a single-headed nail showing item 11, which is the point; item 21, which is the shaft; item 32, which are the vertical helical barbs; item 41, which is a head; item 2C, which is a plan view of a cross-section through the shaft. FIG. 2B shows an isometric front view of a double-headed nail showing item 11, which is the point; item 21, which is the shaft; item 32, which are the vertical helical barbs; item 41, which is a head; item 52, which is a duplex head; item 2C, which is a plan view of a cross-section through the shaft. FIG. 2C shows a plan view of a cross-section of the shaft showing item 21, which is the shaft; item 32, which are the vertical helical barbs. FIG. 3A shows an isometric front view of a single-headed nail showing item 11, which is the point; item 21, which is the shaft; item 33, which are the vertically protruding spikes; item 41, which is a head; item 3C, which is a plan view of a cross-section through the shaft.

FIG. 3B shows an isometric front view of a double-headed nail showing item 11, which is the point; item 21, which is the shaft; item 33, which are the vertically protruding spikes; item 41, which is a head; item 52, which is a duplex head; item 3C, which is a plan view of a cross-section through the shaft.

FIG. 3C shows a plan view of a cross-section of the shaft showing item 21, which is the shaft; item 33, which are the vertically protruding spikes.

FIG. 4A shows an isometric front view of a single-headed nail showing item 11, which is the point; item 21, which is the shaft; item 34, which are the vertically protruding ovals; item 41, which is a head; item 4C, which is a plan view of a cross-section through the shaft.

FIG. 4B shows an isometric front view of a double-headed nail showing item 11, which is the point; item 21, which is the shaft; item 34, which is the vertically protruding ovals; item 41, which is a head; item 52, which is a duplex head; item 4C, which is a plan view of a cross-section through the shaft.

FIG. 4C shows a plan view of a cross-section of the shaft showing item 21, which is the shaft; item 34, which are the vertically protruding ovals.

### DETAILED DESCRIPTION

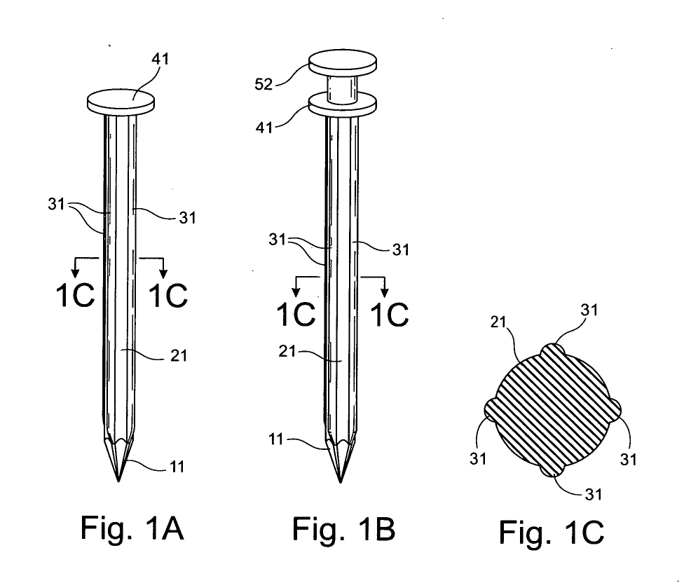

FIG. 1A shows a nail for joining wood, metal, or similar materials to concrete or concrete masonry units in accordance with many embodiments. The nail FIG. 1A includes an elongated tip 11, a body 21, the protruding ribs 31, and a fixed head 41 that are aligned along a longitudinal axis.

To install the nail, a hole must be pre-drilled through the joining wood, metal, or similar material. The hole must penetrate through the cured concrete or concrete masonry unit the depth of the length of the nail or deeper. The nail FIG. 1A can be installed by the use of a hand-held hammer to drive the nail into a pre-drilled hole smaller than the diameter of the nail. By driving the nail into a smaller hole in the concrete, the ribs collapse and create friction between the concrete and themselves. This friction is what gives it the holding strength.

FIG. 1B shows a nail for joining wood, metal, or similar materials to cured concrete or concrete masonry units in accordance with many embodiments. The nail FIG. 1B includes an elongated tip 11, a body 21, the protruding ribs 31, a fixed head 41, and a duplex head 52 that are aligned along a longitudinal axis. To install the nail, a hole must be pre-drilled through the joining wood, metal, or similar material. The hole must penetrate through the cured concrete or concrete masonry unit the depth of the length of the nail or deeper. The nail FIG. 1B can be installed by the use of a hand-held hammer to drive the nail into a pre-drilled hole smaller than the diameter of the nail. By driving the nail into a smaller hole in the cured concrete, the ribs collapse and create friction between the concrete and themselves. This friction is what gives it the holding strength. Removal of the nail FIG. 1B is accomplished with the use of a hammer or a pry bar.

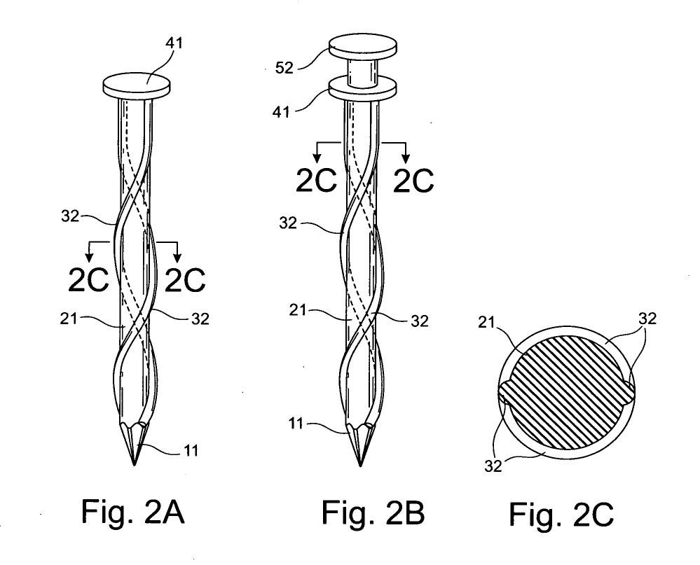

FIG. 2A shows a nail for joining wood, metal, or similar materials to concrete or concrete masonry units in accordance with many embodiments. The nail FIG. 2A includes an elongated tip 11, a body 21, the helical barbs 32, and a fixed head. 41 that are aligned along a longitudinal axis. To install the nail, a hole must be pre-drilled through the joining wood, metal, or similar material. The hole must penetrate through the cured concrete or concrete masonry unit the depth of the length of the nail or deeper. The nail FIG. 2A can be installed by the use of a hand-held hammer to drive the nail into a pre-drilled hole smaller than the diameter of the nail. By driving the nail into a smaller hole in the concrete, the ribs collapse and create friction between the concrete and themselves. This friction is what gives it the holding strength.

FIG. 2B shows a nail for joining wood, metal, or similar materials to cured concrete or concrete masonry units in accordance with many embodiments. The nail FIG. 2B includes an elongated tip 11, a body 21, the helical barbs 32, a fixed head 41, and a duplex head 52 that are aligned along a longitudinal axis. To install the nail, a hole must be pre-drilled through the joining wood, metal, or similar material. The hole must penetrate through the cured concrete or concrete masonry unit the depth of the length of the nail or deeper. The nail FIG. 2B can be installed by the use of a hand-held hammer to drive the nail into a pre-drilled hole smaller than the diameter of the nail. By driving the nail into a smaller hole in the cured concrete, the ribs collapse and create friction between the concrete and themselves. This friction is what gives it the holding strength.

Removal of the nail FIG. 2B is accomplished with the use of a hammer or a pry bar.

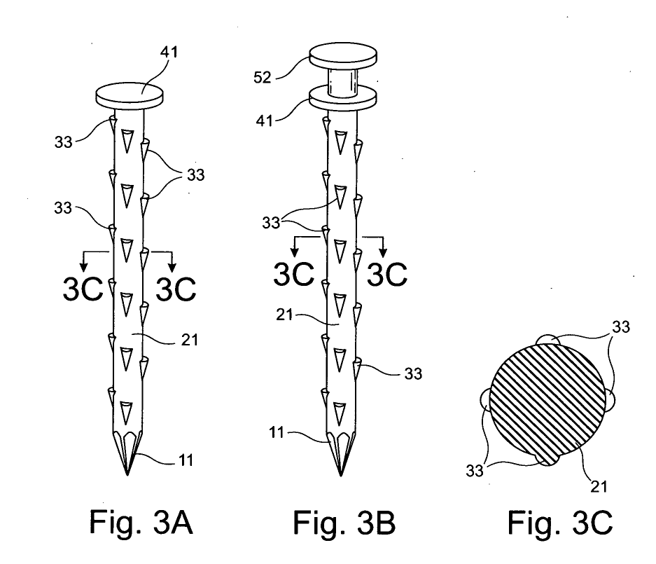

FIG. 3A shows a nail for joining wood, metal, or similar materials to concrete or concrete masonry units in accordance with many embodiments. The nail FIG. 3A includes an elongated tip 11, a body 21, the protruding spikes 33, and a fixed head 41 that are aligned along a longitudinal axis. To install the nail, a hole must be pre-drilled through the joining wood, metal, or similar material. The hole must penetrate through the cured concrete or concrete masonry unit the depth of the length of the nail or deeper. The nail FIG. 3A can be installed by the use of a hand-held hammer to drive the nail into a pre-drilled hole smaller than the diameter of the nail. By driving the nail into a smaller hole in the concrete, the ribs collapse and create friction between the concrete and themselves. This friction is what gives it the holding strength.

FIG. 3B shows a nail for joining wood, metal, or similar materials to cured concrete or concrete masonry units in accordance with many embodiments. The nail FIG. 3B includes an elongated tip 11, a body 21, the protruding spikes 33, a fixed head 41, and a duplex head 52 that are aligned along a longitudinal axis. To install the nail, a hole must be pre-drilled through the joining wood, metal, or similar material. The hole must penetrate through the cured concrete or concrete masonry unit the depth of the length of the nail or deeper. The nail FIG. 3B can be installed by the use of a hand-held hammer to drive the nail into a pre-drilled hole smaller than the diameter of the nail. By driving the nail into a smaller hole in the cured concrete, the ribs collapse and create friction between the concrete and themselves. This friction is what gives it the holding strength.

Removal of the nail FIG. 3B is accomplished with the use of a hammer or a pry bar.

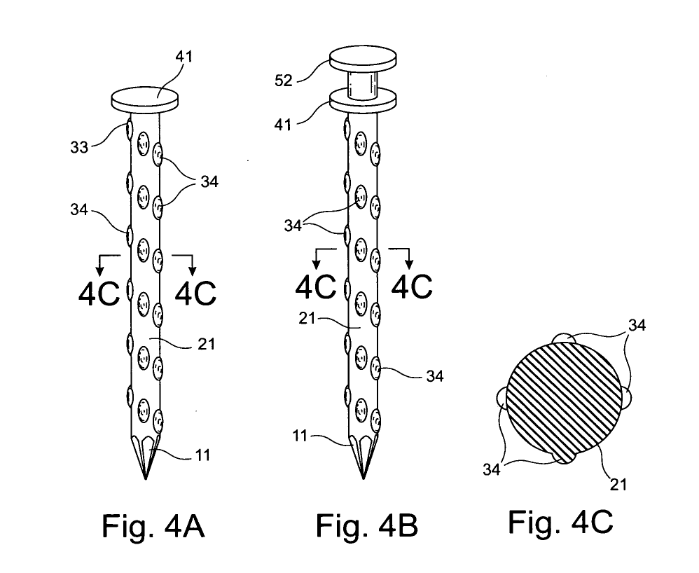

FIG. 4A shows a nail for joining wood, metal, or similar materials to concrete or concrete masonry units in accordance with many embodiments. The nail FIG. 4A includes an elongated tip 11, a body 21, the protruding ovals 34, and a fixed head 41 that are aligned along a longitudinal axis.

To install the nail, a hole must be pre-drilled through the joining wood, metal, or similar material. The hole must penetrate through the cured concrete or concrete masonry unit the depth of the length of the nail or deeper. The nail FIG. 4A can be installed by the use of a hand-held hammer to drive the nail into a pre-drilled hole smaller than the diameter of the nail. By driving the nail into a smaller hole in the concrete, the ribs collapse and create friction between the concrete and themselves. This friction is what gives it the holding strength.

FIG. 4B shows a nail for joining wood, metal, or similar materials to cured concrete or concrete masonry units in accordance with many embodiments. The nail FIG. 4B includes an elongated tip 11, a body 21, the protruding ovals 34, a fixed head 41, and a duplex head 52 that are aligned along a longitudinal axis. To install the nail, a hole must be pre-drilled through the joining wood, metal, or similar material. The hole must penetrate through the cured concrete or concrete masonry unit the depth of the length of the nail or deeper. The nail FIG. 4B can be installed by the use of a hand-held hammer to drive the nail into a pre-drilled hole smaller than the diameter of the nail. By driving the nail into a smaller hole in the cured concrete, the ribs collapse and create friction between the concrete and themselves. This friction is what gives it the holding strength.

Removal of the nail FIG. 4B is accomplished with the use of a hammer or a pry bar.

1. A depth-insensitive concrete fastener for fastening material objects to cured concrete or CMU, permanently or temporarily, comprising: a pre-drilled hole, having a predetermined diametrical extent, defined within said cured concrete or CMU; a material object disposed upon said cured concrete or CMU; and concrete fastener means, comprising a tip portion, a head portion, a duplex head portion, and a shank portion, interconnecting said tip and head portions, for insertion within said pre-drilled hole of said cured concrete or CMU for securing said material object upon said cured concrete or CMU; said shank portion of said anchor fastener means being solid, formed from a material and as a structural component which is substantially non-deformable when driven into said pre-drilled hole defined within said cured concrete or CMU and comprising a portion commencing immediately adjacent to said duplex head portion, comprising a protruding portion interposed between said shank portion and said tip portion and comprising a circumferential array of substantially axially extending protrusions and which have a substantially linear, impact driven manner and with an interference fit defined between said substantially axially extending, uniformly cross-sectioned rib means of said concrete fastener means and said pre-drilled hole defined within said cured concrete or CMU only along said axial extent of said protruding portion of said anchor means so as to render said concrete fastener depth-insensitive regardless of the depth to which said concrete fastener means is driven into said pre-drilled hole defined within said cured concrete or CMU.

2. The depth-insensitive concrete fastener as set forth in claim 1, wherein: said pre-drilled hole has a predetermined axial depth; and said axial extent of said protruding portion of said shank portion of said concrete fastener means is the entire portion of said axial depth of said pre-drilled hole defined within said cured concrete.

3. The concrete fastener as set forth in claim 1, wherein: said tip portion of said ancho fastener means comprises a substantially pointed tip.

4. The concrete fastener as set forth in claim 1, wherein: said shank portion of said anchor fastener means comprises a longitudinal axis; and said substantially extending protrusions are parallel with respect to said longitudinal axis of said shank portion of said ancho fastener means.

5. The concrete fastener as set forth in claim 1, wherein: each one of said multiple protrusions of said protruding portion of said shank portion of said concrete fastener means has various cross-sectional projection configuration.
